(19) United States
(12) Patent Application Publication
(10) Pub. No.: US 2006/0229051 A1
(43) Pub. Date: Oct. 12, 2006

(54) Interference selection and cancellation for CDMA communications

(76) Inventors: Anand P. Narayan, Boulder, CO (US); Vijay Nagarajan, Boulder, CO (US)

Correspondence Address: TENSORCOMM, INC., 1490 W. 121ST AVE., SUITE 105, WESTMINISTER, CO, 80234, US

(21) Appl. No.: 11/100,940

(22) Filed: Apr. 7, 2005

(51) Int. Cl. H04B 1/10

(52) U.S. Cl. 455/296

(57) ABSTRACT

Interference cancellation for CDMA handsets comprises projecting a received signal onto a subspace that is substantially orthogonal to an interference subspace. Selection of the interference subspace includes extracting at least one interfering signal from the received signal. Interference selection may include calculating a signal-power threshold from which the presence or absence of interfering channels is determined. Receiver embodiments are configured for transmit and receive diversity.

### CROSS-REFERENCE TO RELATED APPLICATIONS

This application is related to co-pending U.S. Pat. Appl. entitled “Construction of Projection Operators for Interference Cancellation,” filed on, the entire disclosure and contents of which is hereby incorporated by reference.

### BACKGROUND

1. Field of the Invention

The invention generally relates to the field of signal processing. More specifically the invention is related to efficient mathematical projection of signals for the purpose of reducing the effects of interference.

2. Discussion of the Related Art

Conventional cancellation techniques derive interference estimates, or otherwise approximate interfering signals, via direct measurement and/or analytical methods that employ channel estimation. The interference estimates are then subtracted from the actual received signal to approximate at least one received signal of interest. Uncertainty in the estimates (i.e., estimation noise) introduces uncertainty, or noise, into the cancellation process. For example, in successive interference cancellation, the strongest interference component is detected and removed first. Detection of the strongest component comprises generating a detection statistic that includes an estimate of the transmitted information symbol contributing to the interference and an estimate of the physical-channel conditions that characterize how the interference corrupts the signal of interest.

In CDMA, a received coded data signal may experience inter-symbol interference (ISI) and multiple-access interference (MAI) due to delayed paths (i.e., multipaths) of reflected transmission arriving at the receiver. A CDMA receiver may correlate the received with a spreading code corresponding to a particular interfering multiple-access channel to provide an estimate of the amplitude, phase, and symbol value together. The information estimate and the physical-channel estimate are then used to synthesize an interference signal that is cancelled from the received signal.

Other prior-art cancellation methods employ various techniques to estimate interference. However, the accuracy of interference cancellation used in prior-art systems is typically constrained by the amount of uncertainty in the detection statistics used in the cancellation process. Thus, some embodiments of the invention may be directed toward reducing at least some of the uncertainty introduced by detection statistics.

### SUMMARY OF THE INVENTION

Embodiments of the invention may provide for extracting at least one interference signal directly from a received signal comprising at least one signal of interest and the at least one interference signal. An interference signal, such as used in the present disclosure, may include a multipath signal, a multiple-access channel, and/or an interfering signal intended for a neighboring sector or cell.

Embodiments of the present invention may employ orthogonal projections to achieve interference cancellation. For example, a receiver according to one embodiment of the invention may project a desired signal coupled with interference onto a subspace that is substantially orthogonal or oblique to an interference subspace. Particular embodiments of the invention improve upon prior-art interference-cancellation techniques by circumventing the necessity for physical-channel estimation and physical-channel emulation when constructing an interference subspace.

Embodiments of the invention configured to eliminate physical-channel estimation and associated physical-channel compensation may achieve various benefits and advantages, including (but not limited to) reduced complexity of implementation, and improved accuracy (and thus, performance) by avoiding errors that would otherwise be present in physical-channel compensation.

In particular, some embodiments of the invention may dispense with physical-channel estimation of the received signal. Rather, embodiments of the invention may provide for a soft decision of one or more received interfering data symbols without performing channel compensation. Thus, some embodiments of the invention may provide certain advantages (e.g., reduced system complexity, avoidance of estimation errors, etc.) compared to prior-art interference cancellers that compensate for channel distortions, estimate interfering data symbols, and then employ channel emulation for reconstructing the interfering signals. Similarly, embodiments of the invention may avoid physical-channel estimation, channel-distortion calculations, and/or physical-channel compensation for threshold detection and interference cancellation.

Embodiments of the invention are described with respect to their function in a CDMA transceiver. Such embodiments may be configured for any type of CDMA system, including (but not limited to) IS95, CDMA2000, and W-CDMA systems. Receiver embodiments may include stand-alone receivers, or add-ons to existing CDMA receivers.

An exemplary receiver embodiment of the invention may include at least one interference selector having a coded baseband signal input wherein the interference selector is configured to produce an interference matrix (i.e., an S-matrix) and/or a combined interference vector output. At least one canceller coupled to the at least one interference selector receives the S-matrix and the coded baseband signal input. The canceller produces an interference-cancelled signal output.

The at least one interference selector may be configured to generate the S-matrix from selected interfering signals in the coded baseband signal, but without having to compensate for phase offsets and amplitude variations due to physical-channel distortions. Rather, the at least one interference selector may provide a soft-decision value corresponding to each interfering signal without performing equalization. Benefits of this embodiment may be derived from avoiding the necessity of synthesizing or otherwise reconstructing physical-channel distortions for an interference-cancellation signal. In a CDMA system, an interference space may be selected directly from a PN-stripped version of the coded baseband signal. The interference selector may employ a threshold-determination module, or some other selection means to select interference terms for inclusion in the S-matrix. In some embodiments of the invention, an interference space may be generated from at least one receiver-generated spreading code modulated with measured values of the baseband data.

In one embodiment of the invention, a receiver is configured to select and cancel interfering signals that exceed a predetermined signal strength. In another embodiment, a predetermined number of interfering Walsh channels (e.g., user channels, or multiple-access channels) per path are selected and canceled. Thus, some embodiments of the invention may select all interfering signals that are determined to be present in a particular received signal, while other embodiments may select only signals that meet or exceed a predetermined signal-strength threshold. In one aspect of the invention, the interference selector is configured to cancel only pilot-channel interference. In another aspect of the invention, the interference selector may select coded signals from one or more common MAI channels. The interference selector may select any combination of coded signals occupying user, common, and/or pilot multiple-access channels.

Receiver embodiments of the invention may be configured for receiving signals from a transmit-diversity system. Furthermore, receiver embodiments comprising a plurality of receiver antennas may be configured to provide both interference cancellation and diversity combining.

These and other embodiments of the invention are described with respect to the figures and in the following description of the preferred embodiments.

### BRIEF DESCRIPTION OF THE DRAWINGS

FIG. 1 shows a receiver embodiment of the invention configured to receive a Code-Division Multiplex Access (CDMA) signal.

FIG. 2A illustrates components of an interference selector according to one exemplary embodiment of the invention.

FIG. 2B illustrates an alternative receiver embodiment of the invention configured to perform interference selection and interference cancellation.

FIG. 3A shows a reception method according to one exemplary embodiment of the invention.

FIG. 3B shows a method for performing the interference-extraction step shown in FIG. 3A.

FIG. 4 shows a receiver method and apparatus embodiment of the invention.

FIG. 5 illustrates a method and apparatus for performing threshold determination at a receiver configured to operate in a transmit-diversity system.

### DESCRIPTION OF THE PREFERRED EMBODIMENTS

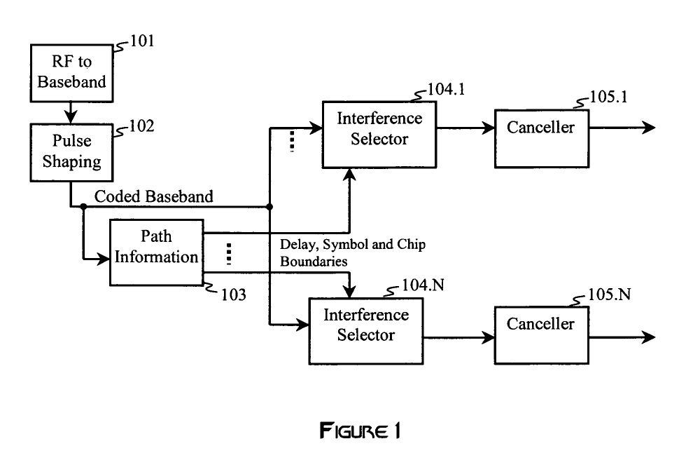

FIG. 1 shows a receiver (e.g., a mobile handset) configured to receive a Code-Division Multiplex Access (CDMA) signal transmitted by at least one base station. This receiver embodiment may process signals received from a transmit-diversity system (e.g., at least one transmitter comprising a plurality of transmitter antenna elements). Signals received at the receiver's antenna include a linear combination of transmissions intended for a plurality of users in the cell. Furthermore, the received signal typically includes multipath distortions and additive noise. An RF-to-baseband module 101 converts the received signal to a down-converted baseband signal, which is then passed through a pulse-shaping filter 102. The down-converted signal is typically not compensated for physical-channel distortions. Since the down-converted signal usually includes in-phase and quadrature-phase components, it is sometimes referred to as an “IQ” signal.

A path-information module 103 identifies a predetermined number of the strongest multipath signals and/or base station signals and supplies pseudo-noise (PN) sequences corresponding to a plurality of interference cancellers 105.1-105.N. The receiver's antenna may include a plurality of antenna elements (e.g., an antenna array) for diversity combining. An appropriate configuration of the RF-to-baseband module 101 and the pulse-shaping filter 102 may be provided relative to multiple RF chains needed for receiver diversity combining. Accordingly, the path-information module 103 may identify antenna/multipath combinations that produce the predetermined number of strongest signals.

The path-information module 103 typically includes a descrambler (not shown) to descramble the IQ signal. The path-information module 103 typically accounts for delays due to multipath propagation. Furthermore, the path-information module 103 may compensate for pre-processing latency, latency due to interference cancellation at the receiver, and time offsets applied by transmitters to transmitted PN sequences. A descrambled signal may be referred to as descrambled data, a PN-stripped signal, or a PN-decoded signal. For the purpose of the exemplary embodiments of the invention, a descrambler (which is typically used in a W-CDMA system to descramble scrambling codes) is functionally equivalent to a despreader, which is typically used in CDMA2000 and IS-95 systems to despread short PN sequences.

The path-information module 103 may correlate the IQ signal with time-shifted versions of a scrambling code or a PN code. However, alternative techniques may be used to resolve the IQ signal into multipath components, such as by correlating the scrambling sequence with time-shifted versions of the IQ signal. In some embodiments, a sliding correlator may be employed. In some CDMA systems (e.g., W-CDMA), the path-information module 103 typically uses a synchronization channel to identify codes and/or code sets used by at least one base station of interest.

Delay information, symbol boundaries, and chip boundaries for each of the strongest paths so identified may be sent as inputs to a plurality N of interference selectors 104.1-104.N along with the IQ signal. The interference selectors 104.1-104.N may identify a linear combination of interference signals (e.g., MAI channels) in at least one path, the channel gain, data constellation rotation (such as resulting from diversity transmission and/or channel gain), and transmit-antenna power distribution (in a transmit-diversity system). The IQ signal and the outputs of the interference selectors 104.1-104.N are coupled to the projection cancellers 105.1-105.N to produce at least one interference-cancelled signal. The at least one interference-cancelled signal is typically coupled to at least one other baseband-processing module, which may include a Rake receiver.

In a conventional Rake receiver, the receiver typically identifies different diversity paths based on coding and pilot signals. In a transmit-diversity system, all transmission paths arriving at the receiver with the same delay may be processed by each of the projection cancellers 105.1-105.N as a single signal for the purpose of cancellation. In a conventional open-loop transmit diversity (OLTD) system, the number of Rake receivers is typically doubled. For example, half of the Rake fingers may be configured to process a primary path and the other half configured to process a diversity path. In this case, the Rake is typically provided with additional signal processing capability to process space-time coding applied to the transmissions.

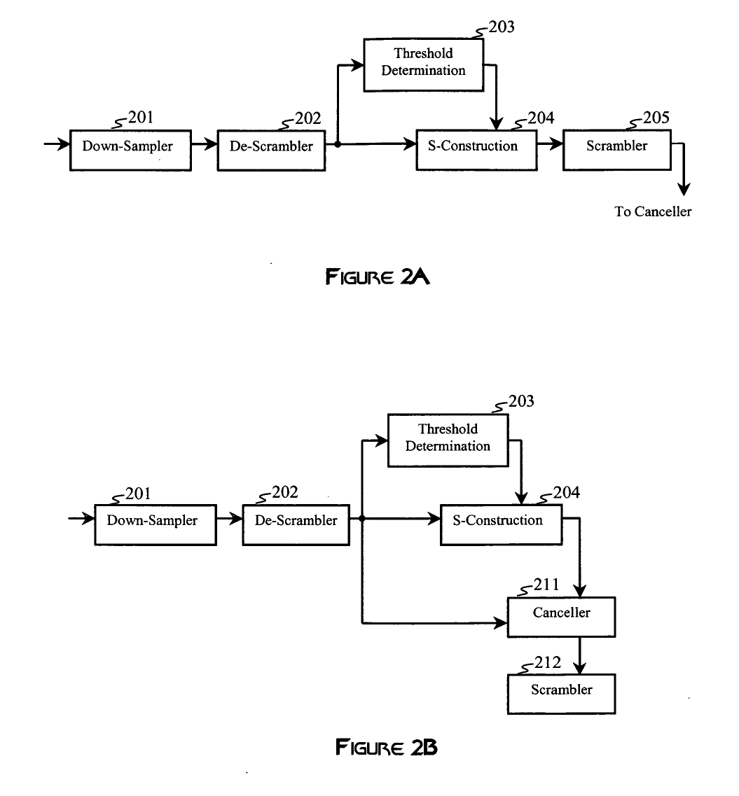

FIG. 2A illustrates components of an interference selector according to one exemplary embodiment of the invention. The IQ is down-sampled 201 with respect to the delay and the symbol and chip boundary information. A de-scrambler block 202 may employ a combination of delay information and PN codes to remove at least one scrambling code per multipath/base station from the down-sampled IQ for at least one particular multipath component. Descrambling is typically performed by multiplying the IQ signal with the complex conjugate of the scrambling code(s). The resulting descrambled signal is sent to a threshold determination block 203 configured to produce a threshold that is used to determine the presence or absence of individual user/common multiple-access channels in the transmission. The threshold and the descrambled signal are coupled into an S-matrix construction block 204, which produces an interference subspace that is expressed as an S-matrix. In some embodiments, the S-matrix construction block 204 may include the threshold-determination block 203.

The S-matrix construction block 204 may optionally add a dc-offset to the interference subspace, such as to approximate and offset a dc interference noise floor. Such a dc interference noise floor may result from estimation errors arising from inter-carrier interference and/or multiple-access interference. A dc interference power level may be determined by averaging channels that are not included in the S-matrix. Thus, the S-matrix construction block 204 may be configured to subtract a constant value corresponding to the dc interference from terms used in constructing the S-matrix. The S-matrix may optionally be re-scrambled prior to being coupled into one of the cancellers 105.1-105.N.

In one embodiment of the invention, the threshold determination block 203 selects a known common channel for determining a threshold. The invention may be configured to produce thresholds from various types of common channels, including pilot channels, paging channels, sync channels, and control channels. For example, in IS-95 and CDMA-2000, the synchronization channel may be employed for threshold determination. Similarly, the threshold determination block 203 configured for W-CDMA may select the Common Control Physical Channel (CCPCH) and/or the Primary Common Pilot Channel (P-CPICH). Alternatively, the threshold determination block 203 may select a traffic channel (i.e., user multiple-access channel) known to be present.

In another embodiment, the threshold determination block 203 may select one or more multiple-access channels having known data or a constant sequence of data symbols. Uncompensated (i.e., non channel-compensated) baseband data on a selected common multiple-access channel is obtained by multiplying the descrambled signal with the complex conjugate of the selected multiple-access channel's orthogonal code. In W-CDMA, orthogonal variable spreading factor (OVSF) codes are used as multiple-access orthogonal codes for spreading data. Alternatively, CDMA2000 and IS-95 employ Walsh covering codes for multiple-access coding. Thus, embodiments of the present invention may be configured to process any of various types of CDMA signals, including W-CDMA, CDMA2000, and IS-95 signals.

Embodiments of the present invention do not require physical-channel information, physical-channel estimates, or physical-channel compensation to perform S-matrix generation or threshold determination. In the case of threshold determination, neither the descrambled signal nor the baseband data is corrected for physical-channel distortion.

In one embodiment of the invention, the threshold may be derived from a function of real and imaginary parts of baseband data. For example, the threshold may be calculated via a function including the absolute value of the real part of the baseband data and/or the absolute value of the imaginary part of the baseband data averaged over one or more data symbols. A preferred embodiment of the invention employs the sum of the absolute values of the real and imaginary parts of the baseband data averaged over a plurality of symbols as an approximation for the magnitude of the baseband data. This preferred embodiment provides substantially less complexity in terms of hardware and/or software compared to calculating the actual magnitude. Furthermore, benefits of less complexity may be achieved without substantially compromising the accuracy of the resulting calculated threshold.

In another embodiment of the invention, threshold determination may employ a plurality of multiple-access channels known to be present over a symbol-duration and use a weighted average of at least some of the channels. In another embodiment of the invention, a threshold value may be provided with a corrective term to compensate for the stochastic nature of data estimates obtained via threshold determination.

The threshold determination block 203 may optionally be bypassed or removed for embodiments in which only the common channel(s) that are always present and are deemed to contribute interference to a signal of interest. In such embodiments, interfering code vectors in the S-matrix correspond only to one or more common channels, which are known to be present.

In embodiments of the invention configured to identify the presence of user multiple-access channels, the threshold determination block 203 may multiply the descrambled signal with the complex conjugate of each of the possible orthogonal multiple-access channel codes to obtain the baseband data. For example, in CDMA2000, there can be as many as 128 orthogonal user codes. Thus, multiplication may include all 128 codes. Embodiments of the invention may be configured to process any number of codes, such as may be required by one or more communication standards. A preferred embodiment of the invention may employ a Fast-Walsh Transform (FWT) on the descrambled data to obtain baseband data. The FWT may optionally be configured to process Walsh codes having different lengths. Such Walsh codes may be used in a communication system that supports multiple data rates. One embodiment of the invention exploits the fact that each Walsh code may be constructed from a concatenation of shorter-length Walsh codes. Thus, the FWT may be configured to decode each of a plurality of constituent Walsh codes for each Walsh code of a given code length (i.e., a full-length Walsh code) to obtain a baseband data estimate for each of the constituent Walsh codes.

The S-matrix construction block 204 and/or the threshold determination block 203 may be configured to determine which multiple-access channels are present. The threshold determination block 203 may be configured to process baseband data derived from a full-length Walsh code, at least one constituent Walsh code, and/or an aggregate of Walsh codes or constituent Walsh codes. In one embodiment of the invention, a baseband signal decoded from at least one multiple-access channel is processed to produce a real part and/or an imaginary part. Absolute values of the real and/or imaginary parts may be compared to the threshold. In other embodiments, functions of the real and imaginary parts may be compared to the threshold. These functions may include similar or different functions relative to those used to produce the threshold.

In one preferred embodiment of the invention, the absolute values of the real and imaginary parts for each multiple-access channel's baseband data are summed and compared to the threshold. If the summed channel values exceed the threshold, that multiple-access channel is considered to be present. Baseband data on a multiple-access channel that does not satisfy the threshold criteria may be replaced with zero to denote its absence. Similarly, baseband data residing on different-length Walsh channels may be zeroed in the same manner. An FWT may be applied to the resulting modified data to produce a linear combination of Walsh-coded data.

In one embodiment of the invention, codes for all multiple-access channels that are identified as being present are stacked column-wise to obtain the S-Matrix. In another embodiment, the S-matrix construction block 204 outputs a linear combination of the user codes wherein each code is weighted with respect to the complex amplitude of the corresponding baseband data. The amplitudes may include any scaled relative amplitudes with respect to the baseband data. Similarly, in an embodiment configured to process interference from only common channels, a linear combination of only the common channels may be provided. In yet another embodiment, a predetermined number of strongest user/common channels may be selected to approximate the total interference. In this embodiment, the linear combination of multiple-access channels may include only the selected strongest channels. A resulting S-matrix is an M×L matrix, where M is the number of interfering signals and L is the code length.

Each interference selector 104.1-104.N may include a scrambler 205 coupled to the S-matrix construction block 204. The scrambler 205 may apply at least one PN code to the signal output from the S-matrix construction block 204, which represents at least some of the interfering multiple-access channels in a received signal. Thus, the output of each interference selector 104.1-104.N may include a scrambled S-matrix representing a linear combination of M interfering signals.

Each canceller 105.1-105.N receives an S-matrix and the IQ signal, and then performs a projection operation to remove interference from the IQ signal. In one embodiment of the invention, the cancellers 105.1-105.N may interpolate the S-matrix relative to at least one up-sampling factor to match the S-matrix sampling rate to that of the IQ. Each canceller 105.1-105.N may include any type of interpolator to over-sample the S-matrix. An exemplary embodiment of the invention may employ a Finite Impulse Response (FIR) raised-cosine interpolation filter with a roll-off factor of 0.22 to approximate the combined effect of transmit and receive pulse-shaping filters. An alternative embodiment may use a linear interpolator.

FIG. 2B illustrates an alternative embodiment of the invention configured to perform both interference selection and interference cancellation. For example, a combination of each of the interference selectors 104.1-104.N and its corresponding canceller 105.1-105.N may be referred to as an estimator/canceller block. Thus, FIG. 2B is a block diagram of components in one exemplary estimator/canceller block.

An IQ signal is input to a down-sampler 201 and input to a de-scrambler 202 configured to remove at least one scrambling code from the down-sampled IQ for at least one particular multipath component. The descrambled IQ signal is coupled into a threshold-determination block 203, an S-matrix construction block 204, and a canceller 211. In this embodiment, the threshold determination block 203 and the S-matrix construction block 204 function as previously described. However, the canceller 211 receives an S-matrix and the descrambled IQ signal. The canceller 211 may interpolate, or up-sample, both the S-matrix and the descrambled IQ signal prior to, or following, performing a projection operation to cancel interference in the descrambled IQ signal.

Although interference selection and interference cancellation are described with respect to each data-symbol interval, embodiments of the invention may be adapted to provide interference cancellation over a fractional symbol interval. For example, an exemplary fractional symbol interval may include an interval comprising one or more chip intervals. In an alternative embodiment, interference cancellation may be performed over multiple symbol intervals.

In one embodiment of the invention, an optional scrambler 212 may be included. In particular, if the system shown in FIG. 2B is configured to output an interference-cancelled signal to a CDMA Rake receiver, an interference-cancelled signal output by the canceller 211 is advantageously conditioned to simulate at least some signal parameters of the IQ signal. Thus, the interference-cancelled signal may be re-scrambled and optionally amplified to substantially the same power level as the IQ signal. Either the canceller 211 or the scrambler 212 may optionally be configured to perform up-sampling and interpolation operations.

In another embodiment of the invention, the system shown in FIG. 2B may be a component of an integrated CDMA receiver design. For example, the system shown in FIG. 2B may reside in each finger of a Rake receiver. Instead of the scrambler 212, the interference-cancelled signal may be coherently combined with similar output signals from other Rake fingers in a maximal ratio combiner (not shown).

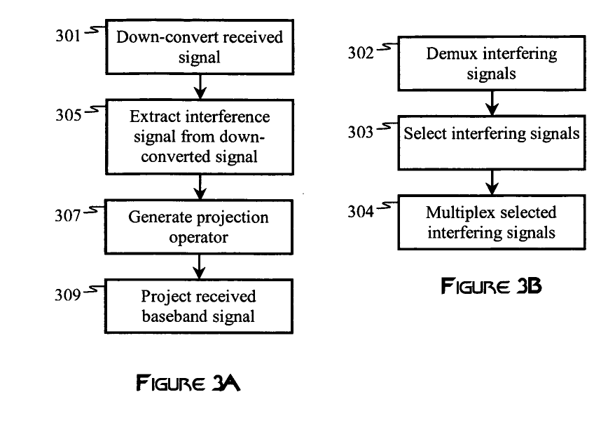

FIG. 3A shows a reception method according to one exemplary embodiment of the invention. A received signal is processed to produce a down-converted signal 301. Interference extraction 305 (which may also be referred to as interference selection) is performed directly on the down-converted signal to select at least one interference signal. For example, rather than explicitly mapping each received signal value to a finite constellation of the transmitted symbols (i.e., performing symbol estimation), interference extraction 305 may provide for a soft decision of each interfering signal. Soft decision is preferable over hard-decision symbol estimation because channel impairments typically distort a received signal's constellation, and mapping the received signals to specific constellation points (even after performing channel compensation) often produces estimation errors. Since the at least one interference signal is produced directly from the down-converted signal rather than being estimated (e.g., performing physical channel estimation followed by a hard decision), the present embodiment may reduce or eliminate errors that would otherwise result from uncertainty in interference signal estimates. The selected interference signal(s) may be used to construct a projection operator 307, such as a projection operator configured to project the down-converted signal onto a subspace that is substantially orthogonal to an interference subspace 309.

FIG. 3B shows a detailed breakdown of the interference-extraction step 305 for a CDMA receiver embodiment of the invention. The down-converted signal is demultiplexed 302 to generate a set of signal values, including at least one interfering signal value. Demultiplexing 302 may be performed simply by processing the down-converted signal with the adjoint of one or more channelization codes or functions, such as used by a transmitter to map data symbols onto potentially interfering multiple-access channels. Demultiplexing 302 may include providing for a soft decision to produce a set of soft-decision signal values for the interfering signals.

A selection process 303 may be performed for each interfering signal, such as to select which interfering signals are present and/or select which signal(s) to include in an interference subspace. Various criteria may be established and comparisons made in the course of the selection process 303. Selected interfering signal values may then be multiplexed together 304 to produce the at least one interfering signal. For example, one or more interfering signal values may be provided with the same channelization codes or functions initially used by a transmitter to map corresponding data symbols to multiple-access channels that have just been selected 303 as interfering channels. Thus, multiplexing 304 may restore the associated channelization to the selected interfering signal values.

Those skilled in the art should recognize that the operations described herein may be implemented in a variety of ways. For example, an interference selector and a projection canceller, such as described herein, may be implemented in hardware, software, firmware or various combinations thereof. Moreover, the matrix generator may also be implemented in hardware, software, firmware or various combinations thereof. Examples of such hardware may include Application Specific Integrated Circuits (“ASIC”), Field Programmable Gate Arrays (“FPGA”), general-purpose processors, Digital Signal Processors (“DSPs”), and/or other circuitry. Examples of software and firmware include Java, C, C++, Matlab, Verilog, VHDL and/or processor specific machine and assembly languages. Accordingly, the invention should only be limited by the language recited in the claims and their equivalents.

Computer programs (i.e., software and/or firmware) implementing the method of this invention will commonly be distributed to users on a distribution medium such as a SIM card, a USB memory interface, or other computer-readable memory adapted for interfacing with a consumer wireless terminal. Similarly, computer programs may be distributed to users via wired or wireless network interfaces. From there, they will often be copied to a hard disk or a similar intermediate storage medium. When the programs are to be run, they will be loaded either from their distribution medium or their intermediate storage medium into the execution memory of the wireless terminal, configuring an onboard digital computer system (e.g. a microprocessor) to act in accordance with the method of this invention. All these operations are well known to those skilled in the art of computer systems.

The term “computer-readable medium” encompasses distribution media, intermediate storage media, execution memory of a computer, and any other medium or device capable of storing for later reading by a digital computer system a computer program implementing the method of this invention.

Various digital computer system configurations can be employed to perform the method embodiments of this invention, and to the extent that a particular system configuration is capable of performing the method embodiments of this invention, it is equivalent to the representative system embodiments of the invention disclosed herein, and within the scope and spirit of this invention.

Once digital computer systems are programmed to perform particular functions pursuant to instructions from program software that implements the method embodiments of this invention, such digital computer systems in effect become special-purpose computers particular to the method embodiments of this invention. The techniques necessary for this programming are well known to those skilled in the art of computer systems.

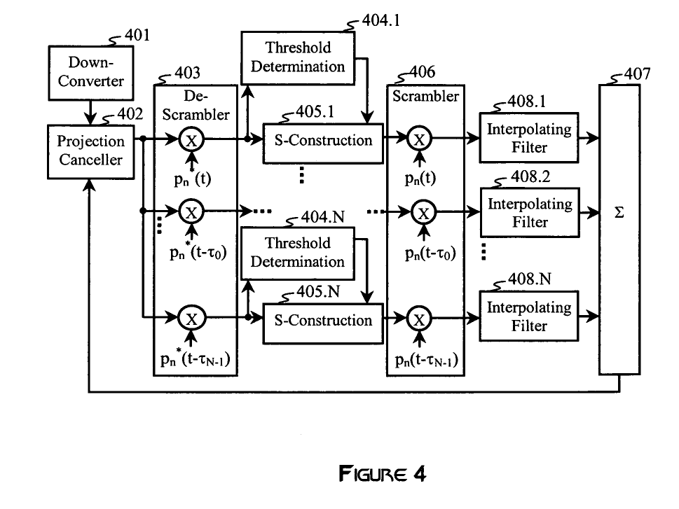

FIG. 4 illustrates a CDMA method and apparatus embodiment of the invention configured to cancel coded interference in a down-converted signal. Such CDMA method and apparatus embodiments may be employed irrespective of the use of transmit diversity. A CDMA receiver provides frequency down-conversion 401 to a received signal to produce the down-converted signal, which is typically a sequence of IQ samples. Pulse shaping (not shown) may be performed on the down-converted signal prior to interference cancellation by a projection canceller 402. The projection canceller 402 may buffer and iteratively modify the IQ signal, such as to recursively produce one or more interference-canceled versions of the IQ signal. A final version of the interference-canceled signal may be used to produce an estimate of data modulated on at least one spreading code.

In a first pass through the projection canceller 402, the down-converted signal is not modified. A descrambler 403 correlates the down-converted signal with a plurality of time-shifted PN codes p*ₙ corresponding to multipath delays at the receiver. The delays typically correspond to a predetermined number of the strongest multipath components arriving at the receiver. Alternatively, a single PN code may be correlated with time-offset versions of the down-converted signal. The descrambler 403 may optionally include a down-sampler (not shown). One or more descrambled signals output from the descrambler 403 are coupled into an interference selector comprising at least one threshold determination module 404.1-404.N and at least one S-matrix construction module 405.1-405.N. N is the number of multipath components.

The at least one S-matrix construction module 405.1-405.N is configured to select at least one interfering user and/or common channel signal from the descrambled signal. The at least one S-matrix construction module 405.1-405.N may zero signals (or otherwise remove multiple-access codes) corresponding to code spaces in which any modulated data value fails to achieve a predetermined threshold. The at least one S-matrix construction module 405.1-405.N may optionally add a dc compensation to selected interference, such as to at least partially compensate for a dc interference floor in the down-converted signal. For example, the S-matrix construction module 405.1-405.M may estimate a dc interference power level by averaging channels that are not included in the S-matrix. Thus, the S-matrix construction module 405.1-405.M may be configured to subtract a constant value corresponding to the dc interference from the terms used in constructing the S-matrix.

The selected interference is re-scrambled by a scrambler 406 configured to reapply the corresponding PN code(s) to the at least one selected interference signal. A plurality of interpolating filters 408.1-408.N may be included for processing a plurality of scrambled interference signals output by the scrambler 406. The scrambled interference signals may optionally be summed 407 prior to being coupled back to the projection canceller 402. For example, to remove interference from a particular multipath component, a plurality of descrambled signals corresponding to other multipath components may be summed. The projection canceller 402 (or other components of the receiver) may include at least one delay module (not shown) configured to delay the baseband signal (i.e., the down-converted baseband signal and/or at least one interference-canceled version of the down-converted signal) and/or the selected scrambled interference signal(s) in order to account for cancellation latency and/or pre-processing latency.

The interference projector 402 may project the original down-converted signal onto a subspace that is substantially orthogonal to a subspace defined by the plurality of scrambled interference signals. A resulting interference-canceled version of the down-converted signal may be output from the interference projector 402 and processed in a symbol estimator (not shown) for at least one symbol of interest. Alternatively, interference-canceled version of the down-converted signal may be output from the descrambler 403. In some embodiments of the invention, the interference-canceled version may be coupled into the descrambler 403 and the interference selection and cancellation processes repeated until a predetermined iteration criterion is satisfied.

Embodiments of the invention may employ a variety of iteration schemes. For example, a provisional estimate of the signal of interest may be evaluated with respect to a predetermined error criterion to determine if another round of interference cancellation is necessary. Other constraints may be used in place of, or in addition to, an error criterion, such as a maximum iteration count criterion. The interference projector 402 may be configured to cancel only one interfering signal component per iteration, or the interference projector 402 may cancel multiple interfering components per iteration. In one embodiment, the interference projector 402 may be configured to cancel a different multipath signal per iteration. In another embodiment, the interference projector 402 may be configured to cancel multiple-access channel interference for a given multipath component per iteration. Combinations and/or variations of such embodiments may also be employed.

Embodiments of the invention may be configured for spatial diversity applications. In a receive-diversity system, at least one Rake receiver coupled to a plurality of antenna elements (e.g., an antenna array) may be provided with at least one interference selector and at least one projection canceller. For example, the system diagram shown in FIG. 1 may be provided with a receiver array input. Each received signal may comprise a linear combination of data for at least one user, wherein the data signal is transmitted from a plurality of antennas and dispersed in a multipath channel. The RF-to-baseband module 101 and the pulse-shaping filter 102 convert the received signal(s) to a down-converted signal. Similarly, FIGS. 2A and 2B illustrate sub-systems that may be included in a receive-diversity system.

A signal received by a receiver of the present invention may include a transmit-diversity signal (i.e., a transmission from a plurality of transmit antennas). OLTD is one of the simplest forms of transmit diversity. OLTD typically involves coding transmitted bits to facilitate recovery and demodulation of received data signals. Diversity coding also enhances performance of a diversity receiver. In W-CDMA, Alamouti Space-time codes are provided for two-antenna transmit diversity.

Closed-loop transmit diversity (CLTD) may include antenna steering and/or beam forming. CLTD typically adapts transmit beam patterns relative to channel conditions and feedback received from the receiver. Embodiments of the invention should not be restricted to any one mode or form of transmit diversity. Rather, the embodiments may be configured to accommodate all transmit-diversity schemes that employ a plurality of antennas at the transmit side.

In a CLTD system, a received signal can be represented by:
y=(h₁w₁+h₂w₂+ . . . +hₙ wₙ)s
where w₁-wₙ represent transmit beam-forming weights, h₁-hₙ represent complex channel coefficients associated with each transmit antenna, s is a data symbol, and n is the number of transmit antennas. An OLTD system employing Space-Time Transmit Diversity (STTD) uses an n×n matrix to transmit coded data over the n transmit antennas for any given time instant. Each data symbol s is mapped to a plurality of coded symbols s₁,S₂, . . . ,sₙ prior to transmission. The down-converted received signal can be expressed by:
y=(h₁s₁+h₂s₂+ . . . +hₙsₙ)
However, since each of the plurality of coded symbols s₁,S₂, . . . ,S₃ is typically selected from a given symbol constellation wherein each symbol is a phase-rotated version of the other symbols, the expression for the down-converted signal can be rewritten as:
y=(h₁w₁+h₂W₂+ . . . +hₙwₙ)s
where w₁ s=s₁, . . .,Wₙ S=Sₙ. Thus, the received signals for both CLTD and OLTD are similar in form. Furthermore, these equations can be generalized to the case in which no transmit diversity is employed:
y=hs
where h is expressed by:
h=(h₁w₁+h₂w₂+ . . . +hₙwₙ)
Thus, a receiver solution configured to solve the equation y=hs, such as the receiver embodiments described herein, may be employed in systems that use various types of transmit diversity and in systems that do not use any transmit diversity. Receiver embodiments of the invention may measure or derive h from one or more common channels.

For example, in either case, the path-information module 103 may identify a predetermined number of the strongest multipath signals via correlation with one or more scrambling (i.e., PN) codes used by the transmitter(s). The receiver performs time-domain reception for each of the identified multipath signals. The projection cancellers 105.1-105.N provide a substantially interference-canceled signal to each of the Rake fingers. If an Alamouti scheme for two transmit antennas is employed, then the number N of Rake fingers or path-based receivers is doubled. Thus, for each multi-path, one finger processes the primary path and a corresponding transmit diversity path. Data estimates from each of these fingers are then usually optimally combined to obtain a combined estimate for the data.

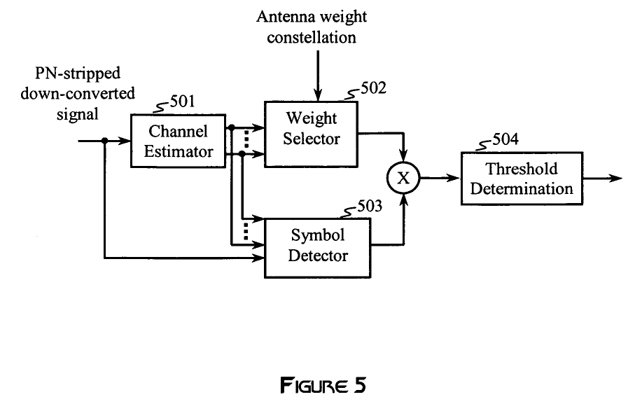

FIG. 5 illustrates a method and apparatus for performing threshold determination at a receiver configured to operate in a transmit-diversity system. Channel estimation 501 may be performed on a PN-stripped version of the down-converted signal to provide estimates of the values h₁ . . . hₙ. For example, in a system employing two transmit antennas, there are two pilot channels with known data bits that can be exploited by the channel estimation 501. Thus, transmit-diversity decoding for these pilot channels may be employed in order to obtain channel information. In W-CDMA, channel estimation may be performed with respect to a received P-CPICH signal and/or a received S-CPICH signal.

Symbol detection 503 may provide channel-compensated data s for a common channel based on the channel estimates h₁ . . . hₙ. In this case, it is assumed that channel estimation and antenna weight selection are performed using conventional approaches commonly employed by a receiver in a transmit-diversity system. In W-CDMA, a P-CCPCH signal may be used as the common channel. Antenna weights w₁ . . . wₙ for the transmit antennas may be advantageously selected 502 (if the weights are constrained to a predetermined constellation of weight values) such that an optimal threshold can be obtained. In W-CDMA mode 2 CLTD, the weights are typically constrained to an 8-PSK constellation. However, other constellations may be used without departing from the essence of the invention.

In an exemplary embodiment of the invention, a threshold determination step 505 produces a threshold from an average of the absolute values of the real and imaginary parts of the following quantity:
T=min_{w}_{ᵢ}_{εU}|h₁w₁+h₂w₂+ . . . +hₙwₙ|s
where U is the finite set of valid antenna weights and s is a symbol estimated from the common channel. In one exemplary embodiment, U comprises a QPSK constellation. In another exemplary (e.g., Mode 2 CLTD of W-CDMA) embodiment, U comprises an 8-PSK constellation. This ensures that all user/common channels with any given set of antenna weights will be detected as being present when compared against the threshold T. In some embodiments of the invention, a corrective term may be added to the threshold in order to account for errors in the estimation processes.

All publications and patent applications mentioned in this specification are herein incorporated by reference to the same extent as if each individual publication or patent application was specifically and individually incorporated by reference.

Various embodiments of the invention may include variations in system configurations and the order of steps in which methods are provided. In many cases, multiple steps and/or multiple components may be consolidated.

The method and system embodiments described herein merely illustrate particular embodiments of the invention. It should be appreciated that those skilled in the art will be able to devise various arrangements, which, although not explicitly described or shown herein, embody the principles of the invention and are included within its spirit and scope. Furthermore, all examples and conditional language recited herein are intended to be only for pedagogical purposes to aid the reader in understanding the principles of the invention. This disclosure and its associated references are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be appreciated by those skilled in the art that the block diagrams herein represent conceptual views of illustrative circuitry, algorithms, and functional steps embodying principles of the invention. Similarly, it should be appreciated that any flow charts, flow diagrams, signal diagrams, system diagrams, codes, and the like represent various processes which may be substantially represented in computer-readable medium and so executed by a computer or processor, whether or not such computer or processor is explicitly shown.

The functions of the various elements shown in the drawings, including functional blocks labeled as “processors” or “systems,” may be provided through the use of dedicated hardware as well as hardware capable of executing software in association with appropriate software. When provided by a processor, the functions may be provided by a single dedicated processor, by a shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, the function of any component or device described herein may be carried out through the operation of program logic, through dedicated logic, through the interaction of program control and dedicated logic, or even manually, the particular technique being selectable by the implementer as more specifically understood from the context.

Any element expressed herein as a means for performing a specified function is intended to encompass any way of performing that function including, for example, a combination of circuit elements which performs that function or software in any form, including, therefore, firmware, micro-code or the like, combined with appropriate circuitry for executing that software to perform the function. Embodiments of the invention as described herein reside in the fact that the functionalities provided by the various recited means are combined and brought together in the manner which the operational descriptions call for. Applicant regards any means which can provide those functionalities as equivalent as those shown herein.

1. A cancellation system comprising:
a projection canceller configured to project a down-converted signal onto a subspace substantially orthogonal or oblique to an interference subspace corresponding to at least one interference signal, and
an interference selector coupled to the projection canceller and configured to extract the at least one interference signal from the down-converted signal.

2. The cancellation system recited in claim 1 configured to receive the baseband signal from at least one radio receiver.

3. The cancellation system recited in claim 1 configured to receive the baseband signal from a receiver antenna array.

4. The cancellation system recited in claim 1 further comprising an RF-to-baseband module.

5. The cancellation system recited in claim 1 further comprising a path-information module.

6. The cancellation system recited in claim 1 wherein the projection canceller is configured to up-sample at least one of the down-converted signal and the at least one interference signal.

7. The cancellation system recited in claim 1 wherein the interference selector includes at least one down sampler.

8. The cancellation system recited in claim 1 wherein the interference selector further comprises a scrambler configured to scramble the at least one interference signal.

9. The cancellation system recited in claim 1 configured to cancel interference over at least one of a set of signal durations, including a data symbol duration, an integer multiple of a symbol duration, a chip duration, an integer multiple of a chip duration, a fraction of a symbol duration, and a fraction of a chip duration.

10. The cancellation system recited in claim 1 configured to process at least one of a set of signals, including IS95 signals, CDMA2000 signals, and W-CDMA signals.

11. The cancellation system recited in claim 1 further comprising a Rake receiver, the projection canceller including at least one signal output coupled to at least one finger of the Rake receiver.

12. The cancellation system recited in claim 1 wherein the interference selector includes at least one S-matrix construction block, and the interference subspace is characterized by at least one S-matrix produced by the at least one S-matrix construction block.

13. The cancellation system recited in claim 12 wherein the at least one S-matrix construction block is configured to add a dc-signal component to the interference subspace.

14. The cancellation system recited in claim 12 wherein the at least one S-matrix construction block is configured to compare baseband data in the down-converted signal to at least one threshold to determine which of a plurality of multiple-access channels is present.

15. The cancellation system recited in claim 12 wherein the at least one S-matrix construction block is configured to process baseband data to produce a function of at least one of a real part of the baseband data and an imaginary part of the baseband data, the S-matrix construction block being further configured to compare the function to at least one threshold.

16. The cancellation system recited in claim 15 wherein the function includes at least one of an absolute value of the real part of the baseband data and an absolute value of the imaginary part of the baseband data.

17. The cancellation system recited in claim 15 further including a threshold detector wherein the function produced by the at least one S-matrix construction block is similar to a function employed by the threshold detector to produce at least one threshold.

18. The cancellation system recited in claim 15 wherein the S-matrix construction block is further configured to replace with zero any multiple-access channel value having a corresponding function that does not satisfy a predetermined threshold criterion.

19. The cancellation system recited in claim 15 wherein the S-matrix construction block is further configured to include in the interference subspace any multiple-access channel values corresponding to a function satisfying a predetermined threshold criterion.

20. The cancellation system recited in claim 12 wherein the S-matrix construction block is further configured to include in the interference subspace only a predetermined number of multiple-access channel values corresponding to a function satisfying a predetermined threshold criterion.

21. The cancellation system recited in claim 20 wherein the predetermined number of multiple-access channel values selected by the S-matrix comprises multiple-access channel values having greater signal strength than non-selected channel values.

22. The cancellation system recited in claim 1 wherein the interference selector further comprises a threshold detector.

23. The cancellation system recited in claim 22 wherein the threshold detector is configured to derive at least one threshold from a function of real and imaginary parts of the down-converted signal.

24. The cancellation system recited in claim 23 wherein the threshold detector is configured to average at least one of the real and the imaginary parts of the down-converted signal over at least one symbol interval.

25. The cancellation system recited in claim 23 wherein the threshold detector is configured to derive the at least one threshold from at least one of an absolute value of the real part of the baseband data and an absolute value of the imaginary part of the baseband data.

26. The cancellation system recited in claim 25 wherein the threshold detector is configured to derive the at least one threshold from a sum of the absolute value of the real part of the baseband data and the absolute value of the imaginary part of the baseband data.

27. The cancellation system recited in claim 22 wherein the threshold detector is configured to derive at least one threshold from a weighted average of a plurality of multiple-access channels.

28. The cancellation system recited in claim 22 wherein the threshold detector is configured to provide at least one threshold value with a corrective term to compensate for data estimates obtained via threshold determination.

29. The cancellation system recited in claim 22 wherein the threshold detector is configured to multiply an input descrambled baseband signal with at least one orthogonal channel code to obtain baseband data.

30. The cancellation system recited in claim 29 wherein the threshold detector is configured to employ a fast Walsh Transform.

31. The cancellation system recited in claim 29 wherein at least one of the threshold detector and an S-matrix construction block is configured to determine which multiple-access channels are present.

32. A cancellation system comprising:
a projection cancellation means configured to project a down-converted signal onto a subspace substantially orthogonal or oblique to an interference subspace corresponding to at least one interference signal, and
an interference selection means configured to process the down-converted signal for extracting therefrom the at least one interference signal.

33. The cancellation system recited in claim 32 configured to receive the baseband signal from at least one radio receiver.

34. The cancellation system recited in claim 32 configured to receive the baseband signal from a receiver antenna array.

35. The cancellation system recited in claim 32 further comprising an RF-to-baseband means.

36. The cancellation system recited in claim 32 further comprising a path-information means.

37. The cancellation system recited in claim 32 wherein the projection cancellation means is configured to up-sample at least one of the down-converted signal and the at least one interference signal.

38. The cancellation system recited in claim 32 wherein the interference selection means includes at least one down-sampler means.

39. The cancellation system recited in claim 32 wherein the interference selection means further comprises a scrambler means configured to scramble the at least one interference signal.

40. The cancellation system recited in claim 32 configured to cancel interference over at least one of a set of signal durations, including a data symbol duration, an integer multiple of a symbol duration, a chip duration, an integer multiple of a chip duration, a fraction of a symbol duration, and a fraction of a chip duration.

41. The cancellation system recited in claim 32 configured to process at least one of a set of signals, including IS95 signals, CDMA2000 signals, and W-CDMA signals.

42. The cancellation system recited in claim 32 further comprising a Rake reception means, the projection cancellation means including at least one signal output coupled to at least one finger of the Rake reception means.

43. The cancellation system recited in claim 32 wherein the interference selection means includes an S-matrix construction means, and the interference subspace is characterized by at least one S-matrix produced by the S-matrix construction means.

44. The cancellation system recited in claim 43 wherein the S-matrix construction means is configured to add a dc-signal component to the interference subspace.

45. The cancellation system recited in claim 43 wherein the S-matrix construction means is configured to compare baseband data in the down-converted signal to at least one threshold to determine which of a plurality of multiple-access channels is present.

46. The cancellation system recited in claim 43 wherein the S-matrix construction means is configured to process baseband data to produce a function of at least one of a real part of the baseband data and an imaginary part of the baseband data, the S-matrix construction means being further configured to compare the function to at least one threshold.

47. The cancellation system recited in claim 46 wherein the function includes at least one of an absolute value of the real part of the baseband data and an absolute value of the imaginary part of the baseband data.

48. The cancellation system recited in claim 46 further including a threshold detection means wherein the function produced by the S-matrix construction means is similar to a function employed by the threshold detection means to produce at least one threshold.

49. The cancellation system recited in claim 46 wherein the S-matrix construction means is further configured to replace with zero any multiple-access channel value having a corresponding function that does not satisfy a predetermined threshold criterion.

50. The cancellation system recited in claim 46 wherein the S-matrix construction means is further configured to include in the interference subspace any multiple-access channel values corresponding to a function satisfying a predetermined threshold criterion.

51. The cancellation system recited in claim 43 wherein the S-matrix construction means is further configured to include in the interference subspace only a predetermined number of multiple-access channel values corresponding to a function satisfying a predetermined threshold criterion.

52. The cancellation system recited in claim 51 wherein the predetermined number of multiple-access channel values selected by the S-matrix comprises multiple-access channel values having greater signal strength than non-selected channel values.

53. The cancellation system recited in claim 32 wherein the interference selection means further comprises a threshold detector.

54. The cancellation system recited in claim 53 wherein the threshold detection means is configured to derive at least one threshold from a function of real and imaginary parts of the down-converted signal.

55. The cancellation system recited in claim 54 wherein the threshold detection means is configured to average at least one of the real and the imaginary parts of the down-converted signal over at least one symbol interval.

56. The cancellation system recited in claim 54 wherein the threshold detection means is configured to derive the at least one threshold from at least one of an absolute value of the real part of the baseband data and an absolute value of the imaginary part of the baseband data.

57. The cancellation system recited in claim 56 wherein the threshold detection means is configured to derive the at least one threshold from a sum of the absolute value of the real part of the baseband data and the absolute value of the imaginary part of the baseband data.

58. The cancellation system recited in claim 53 wherein the threshold detection means is configured to derive at least one threshold from a weighted average of a plurality of multiple-access channels.

59. The cancellation system recited in claim 53 wherein the threshold detection means is configured to provide at least one threshold value with a corrective term to compensate for data estimates obtained via threshold determination.

60. The cancellation system recited in claim 53 wherein the threshold detection means is configured to multiply an input descrambled baseband signal with at least one orthogonal channel code to obtain baseband data.

61. The cancellation system recited in claim 60 wherein the threshold detection means is configured to employ a fast Walsh Transform.

62. The cancellation system recited in claim 60 wherein at least one of the threshold detection means and an S-matrix construction means is configured to determine which multiple-access channels are present.

63. A handset comprising:
a projection canceller configured to project a down-converted signal onto a subspace substantially orthogonal or oblique to an interference subspace corresponding to at least one interference signal, and
an interference selector coupled to the projection canceller and configured to extract the at least one interference signal from the down-converted signal.

64. The handset recited in claim 63 configured to receive the baseband signal from at least one radio receiver.

65. The handset recited in claim 63 configured to receive the baseband signal from a receiver antenna array.

66. The handset recited in claim 63 further comprising an RF-to-baseband module.

67. The handset recited in claim 63 further comprising a path-information module.

68. The handset recited in claim 63 wherein the projection canceller is configured to up-sample at least one of the down-converted signal and the at least one interference signal.

69. The handset recited in claim 63 wherein the interference selector includes at least one down sampler.

70. The handset recited in claim 63 wherein the interference selector further comprises a scrambler configured to scramble the at least one interference signal.

71. The handset recited in claim 63 configured to cancel interference over at least one of a set of signal durations, including a data symbol duration, an integer multiple of a symbol duration, a chip duration, an integer multiple of a chip duration, a fraction of a symbol duration, and a fraction of a chip duration.

72. The handset recited in claim 63 configured to process at least one of a set of signals, including IS95 signals, CDMA2000 signals, and W-CDMA signals.

73. The handset recited in claim 63 further comprising a Rake receiver, the projection canceller including at least one signal output coupled to at least one finger of the Rake receiver.

74. The handset recited in claim 63 wherein the interference selector includes at least one S-matrix construction block, and the interference subspace is characterized by at least one S-matrix produced by the at least one S-matrix construction block.

75. The handset recited in claim 74 wherein the at least one S-matrix construction block is configured to add a dc-signal component to the interference subspace.

76. The handset recited in claim 74 wherein the at least one S-matrix construction block is configured to compare baseband data in the down-converted signal to at least one threshold to determine which of a plurality of multiple-access channels is present.

77. The handset recited in claim 74 wherein the at least one S-matrix construction block is configured to process baseband data to produce a function of at least one of a real part of the baseband data and an imaginary part of the baseband data, the S-matrix construction block being further configured to compare the function to at least one threshold.

78. The handset recited in claim 77 wherein the function includes at least one of an absolute value of the real part of the baseband data and an absolute value of the imaginary part of the baseband data.

79. The handset recited in claim 77 further including a threshold detector wherein the function produced by the at least one S-matrix construction block is similar to a function employed by the threshold detector to produce at least one threshold.

80. The handset recited in claim 77 wherein the S-matrix construction block is further configured to replace with zero any multiple-access channel value having a corresponding function that does not satisfy a predetermined threshold criterion.

81. The handset recited in claim 77 wherein the S-matrix construction block is further configured to include in the interference subspace any multiple-access channel values corresponding to a function satisfying a predetermined threshold criterion.

82. The handset recited in claim 74 wherein the S-matrix construction block is further configured to include in the interference subspace only a predetermined number of multiple-access channel values corresponding to a function satisfying a predetermined threshold criterion.

83. The handset recited in claim 82 wherein the predetermined number of multiple-access channel values selected by the S-matrix comprises multiple-access channel values having greater signal strength than non-selected channel values.

84. The handset recited in claim 63 wherein the interference selector further comprises a threshold detector.

85. The handset recited in claim 84 wherein the threshold detector is configured to derive at least one threshold from a function of real and imaginary parts of the down-converted signal.

86. The handset recited in claim 85 wherein the threshold detector is configured to average at least one of the real and the imaginary parts of the down-converted signal over at least one symbol interval.

87. The handset recited in claim 85 wherein the threshold detector is configured to derive the at least one threshold from at least one of an absolute value of the real part of the baseband data and an absolute value of the imaginary part of the baseband data.

88. The handset recited in claim 87 wherein the threshold detector is configured to derive the at least one threshold from a sum of the absolute value of the real part of the baseband data and the absolute value of the imaginary part of the baseband data.

89. The handset recited in claim 84 wherein the threshold detector is configured to derive at least one threshold from a weighted average of a plurality of multiple-access channels.

90. The handset recited in claim 84 wherein the threshold detector is configured to provide at least one threshold value with a corrective term to compensate for data estimates obtained via threshold determination.

91. The handset recited in claim 84 wherein the threshold detector is configured to multiply an input descrambled baseband signal with at least one orthogonal channel code to obtain baseband data.

92. The handset recited in claim 91 wherein the threshold detector is configured to employ a fast Walsh Transform.

93. The handset recited in claim 91 wherein at least one of the threshold detector and an S-matrix construction block is configured to determine which multiple-access channels are present.

94. A method for canceling interference in a received signal comprising:
providing for extracting at least one interference signal from a down-converted signal, and
providing for projecting the down-converted signal onto a subspace substantially orthogonal or oblique to an interference subspace corresponding to the at least one interference signal.

95. The method recited in claim 94 wherein providing for extracting at least one interference signal comprises:
providing for demultiplexing the down-converted signal into a plurality of multiple-access channel values including one or more interference values,
providing for selecting at least one of the one or more interference values to produce at least one selected interference value, and
providing for multiplexing the at least one selected interference value to produce the at least one interference signal.

96. The method recited in claim 95 wherein providing for selecting at least one of the one or more interference values provides for selecting the one or more interference values relative to a predetermined threshold.

97. The method recited in claim 95 wherein providing for selecting at least one of the one or more interference values includes selecting a predetermined number of the one or more interference values.

98. The method recited in claim 94 preceded by providing for performing RF-to-baseband conversion on the received signal to produce the down-converted signal.

99. The method recited in claim 94 preceded by providing for receiving the received signal with an antenna array.

100. The method recited in claim 94 preceded by providing for receiving the received signal wherein the received signal originates from at least one transmit antenna.

101. The method recited in claim 94 wherein providing for extracting at least one interference signal further comprises providing for alignment of the received signal relative to at least one of delay information, symbol boundaries, and chip boundaries.

102. The method recited in claim 94 wherein providing for projecting the down-converted signal further comprises providing for up-sampling at least one of the down-converted signal and the at least one interference signal.

103. The method recited in claim 94 wherein providing for extracting at least one interference signal includes providing for down sampling the down-converted signal.

104. The method recited in claim 94 wherein providing for extracting at least one interference signal further comprises providing for scrambling the at least one interference signal.

105. The method recited in claim 94 configured to cancel interference over at least one of a set of signal durations, including a data symbol duration, an integer multiple of a symbol duration, a chip duration, an integer multiple of a chip duration, a fraction of a symbol duration, and a fraction of a chip duration.

106. The method recited in claim 94 configured to process at least one of a set of down-converted signals, including IS95 signals, CDMA2000 signals, and W-CDMA signals.

107. The method recited in claim 94 wherein providing for projecting the down-converted signal generates at least one interference-canceled signal, the method further comprising providing for coupling the at least one interference-canceled signal into at least one finger of a Rake receiver.

108. The method recited in claim 94 wherein providing for extracting at least one interference signal comprises providing for generating an S-matrix.

109. The method recited in claim 108 wherein providing for generating the S-matrix includes providing for adding a dc-signal component.

110. The method recited in claim 108 wherein providing for generating the S-matrix includes providing for including a predetermined number of data values

111. The method recited in claim 108 wherein providing for generating the S-matrix includes providing for comparing baseband data in the down-converted signal to at least one threshold to determine which of a plurality of channels is present.

112. The method recited in claim 111 wherein providing for generating the S-matrix includes providing for generating the at least one threshold from a sum of an absolute value of a real part of the baseband data and an absolute value of an imaginary part of the baseband data.

113. The method recited in claim 111 wherein providing for generating the S-matrix includes providing for deriving the at least one threshold from a weighted average of the plurality of channels.

114. The method recited in claim 111 wherein providing for generating the S-matrix includes providing the at least one threshold with a corrective term to compensate for data estimates obtained via threshold determination.

115. The method recited in claim 111 wherein providing for generating the S-matrix includes providing for processing the baseband data to produce a function of at least one of a real part of the baseband data and an imaginary part of the baseband data, and providing for comparing the function to at least one threshold.

116. The method recited in claim 115 wherein the function produced by providing for processing the baseband data includes at least one of an absolute value of the real part of the baseband data and an absolute value of the imaginary part of the baseband data.

117. The method recited in claim 115 wherein the function produced by providing for processing the baseband data and a function employed to produce the at least one threshold are substantially identical.

118. The method recited in claim 115 wherein providing for comparing the function to at least one threshold further comprises setting to zero any of the baseband data having a corresponding function that does not satisfy a predetermined threshold criterion.

119. The method recited in claim 115 wherein providing for generating the S-matrix further comprises including in the S-matrix any spreading codes of the baseband data having a corresponding function that satisfies a predetermined threshold criterion.

120. A method for calculating a threshold for a receiver configured to operate in a communication system employing transmit-diversity, the method comprising:
providing for determining channel estimates,
providing for estimating transmit antenna weights,
providing for estimating at least one transmitted symbol, and
providing for constructing the threshold from the channel estimates, the estimated antenna weights, and the at least one transmitted symbol.

121. The method recited in claim 120 wherein providing for estimating transmit antenna weights comprises estimating the antenna weights from a predetermined set of possible antenna weights.

122. The method recited in claim 120 wherein providing for estimating the at least one transmitted symbol includes estimating at least one transmitted symbol transmitted in at least one common channel.

123. The method recited in claim 120 wherein providing for determining channel estimates includes measuring at least one common channel.

124. The method recited in claim 120 wherein providing for constructing the threshold comprises generating the threshold from an average of absolute values of a real part and an imaginary part of a quantity derived from the channel estimates, the estimated antenna weights, and the at least one transmitted symbol.

125. An apparatus configured for calculating a threshold in a receiver configured to operate in a communication system employing transmit-diversity, the apparatus comprising:
a channel estimator configured to determine channel estimates,
a weight estimator configured to estimate transmit antenna weights to produce estimated channel weights,
a symbol estimator configured to estimate at least one transmitted symbol to produce at least one transmitted symbol estimate, and
a threshold determination module configured to calculate the threshold from the channel estimates, the estimated antenna weights, and the at least one transmitted symbol estimate.

126. The apparatus recited in claim 125 wherein the weight estimator is configured to estimate the transmit antenna weights from a predetermined set of possible antenna weights.

127. The apparatus recited in claim 125 wherein the symbol estimator is configured to estimate at least one transmitted symbol transmitted in at least one common channel.

128. The apparatus recited in claim 125 wherein the threshold determination module is configured to generate the threshold from an average of absolute values of a real part and an imaginary part of a quantity derived from the channel estimates, the estimated antenna weights, and the at least one transmitted symbol.

129. A handset configured to operate in a communication system employing transmit-diversity, the handset comprising:
a channel estimator configured to determine channel estimates,
a weight estimator configured to estimate transmit antenna weights to produce estimated channel weights,
a symbol estimator configured to estimate at least one transmitted symbol to produce at least one transmitted symbol estimate, and
a threshold determination module configured to calculate the threshold from the channel estimates, the estimated antenna weights, and the at least one transmitted symbol estimate.

130. The handset recited in claim 129 wherein the weight estimator is configured to estimate the transmit antenna weights from a predetermined set of possible antenna weights.

131. The handset recited in claim 129 wherein the symbol estimator is configured to estimate at least one transmitted symbol transmitted in at least one common channel.

132. The handset recited in claim 129 wherein the threshold determination module is configured to generate the threshold from an average of absolute values of a real part and an imaginary part of a quantity derived from the channel estimates, the estimated antenna weights, and the at least one transmitted symbol.

133. A digital computer system programmed to perform the method recited in claim 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, or 124.

134. A computer-readable medium storing a computer program implementing the method of claim 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, or 124.
